(19) United States
(12) Patent Application Publication
(10) Pub. No.: US 2024/0234804 A1
(43) Pub. Date: Jul. 11, 2024

(54) NEW METHOD FOR THE PREPARATION OF A LI-P-S-O PRODUCT AND CORRESPONDING PRODUCTS

(71) Applicants: Solvay SA, Bruxelles (BE); Centre National de la Recherche Scientifique, Paris (FR); UNIVERSITE DE PICARDIE JULES VERNE, Amiens (FR)

(72) Inventors: Marc-David Braida, Bry-sur-Marne (FR); Thierry Le Mercier, Rosny-sous-Bois (FR); Omer Kudu, Amiens (FR); Christian Masquelier, Boves (FR)

(73) Assignees: Solvay SA, Bruxelles (BE); Centre National de la Recherche Scientifique, Paris (FR); UNIVERSITE DE PICARDIE JULES VERNE, Amiens (FR)

(21) Appl. No.: 18/577,114

(22) PCT Filed: Jul. 4, 2022
(86) PCT No.: PCT/EP2022/068407

§ 371 Date: Jan. 5, 2024

(30) Foreign Application Priority Data
Jul. 6, 2021 (EP) 21315121.0

(51) Int. Cl. H01M 10/0562; C01B 25/14

(52) U.S. Cl. CPC H01M 10/0562; C01B 25/14; C01P 2002/72; C01P 2002/76; C01P 2002/82; C01P 2002/86; C01P 2006/40; H01M 2300/0071

(57) ABSTRACT

The present invention concerns a new method for the preparation of a Li—P—S—O product, as well as the products obtainable by said methods, and uses thereof especially as solid electrolytes.

This application claims priority filed on 6 Jul. 2021 in EUROPE with Nr 21315121.0, the whole content of this application being incorporated herein by reference for all purposes.

The present invention concerns a new method for the preparation of a Li—P—S—O product, as well as the products obtainable by said methods, and uses thereof especially as solid electrolytes.

### PRIOR ART

Lithium batteries are used to power portable electronics and electric vehicles owing to their high energy and power density. Conventional lithium batteries make use of a liquid electrolyte that is composed of a lithium salt dissolved in an organic solvent. The aforementioned system arises security questions as the organic solvents are flammable. Lithium dendrites forming and passing through the liquid electrolyte medium can cause short circuit and produce heat, which result in accident that leads to serious injuries.

Non-flammable inorganic solid electrolytes offer a solution to the security problem. Furthermore, their mechanic stability helps suppressing lithium dendrite formation, preventing self-discharge and heating problems, and prolonging the life-time of a battery.

Solid sulfide electrolytes are advantageous for lithium battery applications due to their high ionic conductivities and mechanical properties. These electrolytes can be pelletized and attached to electrode materials by cold pressing, which eliminates the necessity of a high temperature assembly step. Elimination of the high temperature sintering step removes one of the challenges against using lithium metal anodes in lithium batteries.

There is thus a need for new solid sulfide electrolytes.

Li₇P₃S₁₁ is a Li—P—S product which possesses a very high Li⁺ conductivity (1.4×10⁻³ S cm⁻¹ at 25° C. after cold pressing)(Y. Seino, T. Ota, K. Takada, A. Hayashi, M. Tatsumisago, A sulphide lithium super ion conductor is superior to liquid ion conductors for use in rechargeable batteries, Energy Environ. Sci. 7 (2014) 627-631; see [16]). However, it suffers from low chemical and electrochemical stabilities. In order to circumvent these drawbacks, some efforts have been spent to increase its stabilities by introducing O²⁻ ions in its structure [9-12,15]. Conventionally, glass-ceramic Li₇P₃S₁₁ [7] is synthesized by reacting P₂S₅ and Li₂S, the latter of which is substantially expensive. The oxy-sulfide derivatives of Li₇P₃S₁₁ are generally synthesized by adding moisture-stable Li₂O, P₂O₅ or Li₃PO₄ in the conventional precursor mixture (Li₂S—P₂S₅), which are moisture sensitive. Even though the oxy-sulfide end-product are chemically and electrochemically more stable [9-12,15], the synthesis still needs to be performed in an inert atmosphere due to the moisture-sensitive reagents Li₂S and P₂S₅, which are not chemically stable in ambient atmosphere, which remains an expensive problem for up-scaled synthesis.

### INVENTION

The aim of the present invention is to provide a new solid electrolyte, comprising in particular Li₇P₃S_{11-x/2}O_{x/2}, wherein 0<x≥1.

Another aim of the present invention is to provide a new process for the preparation of a Li—P—S—O product such as Li₇P₃S_{11-x/2}O_{x/2} wherein 0<x≤1, without requiring the use of Li₂S and P₂S₅ as reagents.

Another aim of the present invention is to provide a new process for the preparation of a Li—P—S—O product such as Li₇P₃S_{11-x/2}O_{x/2} wherein 0<x≤1, without requiring working in a protected atmosphere for the whole process.

Therefore, the present invention relates to a method of preparing a Li—P—S—O product, the method comprising at least the following steps:
(a) mixing at least Li₄P₂S₆, sulfur, an oxygen containing reagent selected from Li₂CO₃, Li₂O or mixture thereof and optionally Li₂S to obtain a first mixture;
(b) heating the first mixture in an inert atmosphere, under vacuum or under H₂S flow, for a period of time and at a temperature sufficient to produce the Li—P—S—O product; and
(c) cooling and optionally powdering the Li—P—S—O product.

Such process is a new synthesis pathway for the synthesis of solid oxy-sulfide electrolyte responding to formula Li₇P₃S_{11-x/2}O_{x/2} having high ionic conductivity. Just for the sake of example, 70Li₂S-27P₂S₅·3P₂O₅ (or Li₇P₃S_{10.25}O_{0.75}) electrolyte displays ionic conductivity of 2.61×10⁻³ S·cm⁻¹ which outperforms compared to pristine Li₇P₃S₁₁ which displays ionic conductivity of 1.35×10⁻³ S·cm⁻¹ [17].

Contrarily to the existing reaction pathways that require the use of Li₂S and P₂S₅ as reagents, which are not chemically stable in ambient atmosphere, this process uses an Li—P—S compound (i.e. Li₄P₂S₆) as a reagent for synthesis of Li—P—S—O compound (i.e. abovementioned Li₇P₃S_{11-x/2}O_{x/2}). An advantage of this specific reaction is that it promotes the possibility of using Li₄P₂S₆ as the storage material merely in a dry room prior to the synthesis of Li₇P₃S_{11-x/2}O_{x/2}, whereas the conventional reagents Li₂S and P₂S₅ are needed to be stored in a protected atmosphere such as Ar or N. Another advantage is the use of Li₂CO₃ (or Li₂O) which are affordable moisture stable reagents.

### Definitions

Throughout this specification, unless the context requires otherwise, the word “comprise” or “include”, or variations such as “comprises”, “comprising”, “includes”, including” will be understood to imply the inclusion of a stated element or method step or group of elements or method steps, but not the exclusion of any other element or method step or group of elements or method steps. According to preferred embodiments, the word “comprise” and “include”, and their variations mean “consist exclusively of”.

As used in this specification, the singular forms “a”, “an” and “the” include plural aspects unless the context clearly dictates otherwise. The term “and/or” includes the meanings “and”, “or” and also all the other possible combinations of the elements connected to this term.

The term “between” should be understood as being inclusive of the limits.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example.

### DETAILED INVENTION

The method of the invention thus leads to a Li—P—S—O product, that is to say a product comprising lithium (Li), phosphorus (P) and sulfur (S) and oxygen (O).

According to an embodiment, the Li—P—S—O product is chosen in the group consisting of: LiP₃S_{11-x/2}O_{x/2}, Li₃PS_{4-x/2}O_{x/2} and Li₇PS_{6-5x/2}O_{5x/2} wherein 0<x≤1.

More preferably, the Li—P—S—O product is Li₃P₃S_{11-x/2}O_{x/2}.

Without being bound to any theory, the reactions suitable to obtain the Li—P—S—O products can be written as (with 0<x≤1):

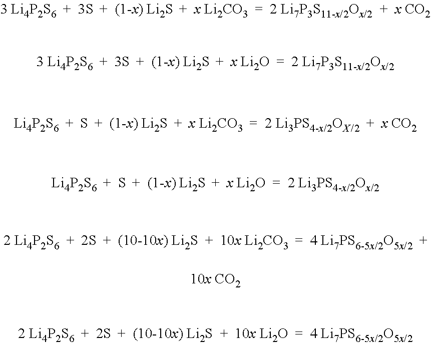

As mentioned above, step (a) of the process according to the invention consists in the preparation of a first mixture from Li₄P₂S₆, sulfur, an oxygen containing reagent selected from Li₂CO₃, Li₂O or mixture thereof and optionally Li₂S.

In some embodiments the oxygen containing reagent comprises Li₂O. In some other embodiments the oxygen containing reagent comprises Li₂O and the first mixture is free from Li₂S. In some embodiments, the first mixture consists of Li₄P₂S₆, sulfur and Li₂O.

In some embodiments the oxygen containing reagent comprises Li₂CO₃. In some other embodiments the oxygen containing reagent comprises Li₂CO₃ and the first mixture is free from Li₂S. Good results were obtained with a first mixture consisting of Li₄P₂S₆, sulfur and Li₂CO₃.

Such step (a) is carried out by implementing usual means well-known from the skilled person.

Preferably, step (a) consists in a chemo-mechanical or mechanochemical reaction.

Then, according to step (b), said mixture is heated in an inert atmosphere, under vacuum or under H₂S flow, for a period of time and at a temperature sufficient to produce the Li—P—S—O product.

As mentioned above, step (b) may be carried out in an inert atmosphere or under vacuum. Step (b) may also comprise an additional sulfur source when this step is carried out under H₂S flow.

Such heating step is carried out by implementing usual means well-known from the skilled person, for example using a vacuum-sealed quartz tube, a batch furnace or a rotary furnace able to work under argon, nitrogen or H₂S flow.

According to an embodiment, the temperature in step (b) is comprised from 150° C. to 600° C., preferably from 180° C. to 300° C.

According to an embodiment, the heating in step (b) is made over a period of time comprised from 0.1 hour to 200 hours, for example from 0.5 hours to 100 hours.

Step (c) consists in cooling the product obtained after step (b). Preferably, this product is cooled down until it reaches the room temperature. Such cooling step is carried out by implementing usual means well-known from the skilled person, such as for instance by letting the furnace going down at room temperature at a rate of 5° C./min.

In particular, this cooling is carried out under natural cooling for a time sufficient to obtain a cooled product having a temperature of about the room temperature.

Within the present invention, the room temperature is defined as being of about 25° C.±2° C.

The method of the invention may also comprise a further step of powdering. Such step is carried out after the cooling step. Such powdering step is carried out by implementing usual means well-known from the skilled person, such as for instance, by crushing the sample in a mortar, or applying a low energy deagglomeration step.

Then, after step (c), the Li—P—S—O is recovered by any means well-known for the skilled person, such as for instance, sieving the powder.

According to an embodiment, Li₄P₂S₆ added in step (a) is obtained from the reaction between Li₂S and P₂S₅. Such reaction is well described in prior art and well-known from the skilled person, such as for instance high temperature solid state reaction as described in Journal of Solid State Chemistry, 43 (1982), pp. 151-162.

The present invention also relates to the Li—P—S—O product obtainable by the method as defined above.

As mentioned above, the Li—P—S—O product is chosen in the group consisting of Li₇P₃S_{11-x/2}O_{x/2}, Li₃PS_{4-x/2}O_{x/2}, and Li₇PS_{6-5x/2}O_{5x/2}, with 0<x≤1. Preferably, the present invention thus relates to Li₇P₃S_{11-x/2}O_{x/2} obtainable by the method as defined above.

The implementation of the method of the invention gives a specific Li—P—S—O product of formula Li₇P₃S_{11-x/2}O_{x/2} having a crystal structure with the same space group (P-1) and different lattice parameters compared to the space group and lattice parameters of the Li—P—S—O products obtained by the prior art methods.

So, the present invention also relates to a Li—P—S—O product of formula Li₇P₃S_{11-x/2} O_{x/2} having a crystal structure (with the space group P-1) and a volume V per formula unit (V/z) at room temperature comprised between 405 and 415 angstrom cube, as measured by X-Ray Diffraction.

The present invention also relates to a Li—P—S—O product of formula Li₇P₃S_{10.5}O_{0.5} (x=1) having a crystal structure (with the space group P-1) and a volume V per formula unit (V/z) at room temperature comprised between 405 and 415 angstrom cube, as measured by X-Ray Diffraction.

The X-ray Diffraction (XRD) measurements were performed for example using Bragg-Brentano geometry with Cu (K-alpha1, K-alpha2) radiation within a D8 Bruker Diffractometer. The preferred measurement conditions were of 15 second per 0.03 degrees step.

The volume V per formula unit is determined using the cell (lattice) parameters acquired at standard atmosphere (101325 Pa) on powder samples.

The volume V per formula unit is the lattice volume V divided by the number of formula units Z in a cell, and Z is equal to 2 (Solid State Ionics, 178 (2007), pp. 1163-1167).

As well known, V′ is derived from cell (lattice) parameters (a, b, c, α, β, γ).

V=a·b·c·sqrt(1+2 cos α·cos β·cos γ−cos²α−cos²β−cos²γ)
(a, b and c being (in Ångstroms (Å)) the lengths of sides (edges) and α, β and γ being the angles (°) between them).

According to an embodiment, the Li—P—S—O product of formula Li₇P₃S_{11-x/2}O_{x/2} according to the invention may also comprise an amorphous phase.

Preferably, the Li—P—S—O product of formula Li₇P₃S_{11-x/2}O_{x/2} according to the invention is a product wherein lattice parameters of the crystal structure, as measured by X-Ray Diffraction, are between these values:
a=12.35−12.50 Å according to the Le Bail method
b=6.01−6.05 Å according to the Le Bail method
c=12.43−12.53 Å according to the Le Bail method

According to an embodiment, the Li—P—S—O product of formula Li₇P₃S_{11-x/2}O_{x/2} according to the invention is a product wherein lattice parameters of the crystal structure, as measured by X-Ray Diffraction, are between these values:
alpha=102.44°−103.14° according to the Le Bail method
beta=112.88°−113.33° according to the Le Bail method
gamma=74.47°−74.71° according to the Le Bail method

The present invention also relates to the use of the Li—P—S—O product as defined above, alone or in combination with any crystalline or amorphous conductive Li-material, as solid electrolyte.

Preferably, the present invention relates to the use of the Li—P—S—O product of formula Li₇P₃S_{11-x/2}O_{x/2} as defined above, in particular having a crystal structure (with the space group P-1) and a volume V per formula unit (V/z) at room temperature comprised between 405 and 415 angstrom cube, as measured by X-Ray Diffraction, alone, as solid electrolyte.

Said solid electrolytes comprises then at least a Li—P—S—O product of formula Li₇P₃S_{11-x/2}O_{x/2} as defined above and optionally another solid electrolyte, such as a lithium argyrodites, lithium thiophosphates, such as glass or glass ceramics Li₃PS₄, Li₇P₃S₁₁, and lithium conducting oxides such as lithium stuffed garnets Li₇La₃Zr₂O₁₂ (LLZO), sulfide.

According to an embodiment, said Li—P—S—O product may be used in combination with any crystalline or amorphous conductive Li-material, such as for instance beta-Li₃PS₄ or glassy Li₃PS₄.

Said solid electrolytes may also optionally comprise polymers such as styrene butadiene rubbers, organic or inorganic stabilizers such as SiO₂ or dispersants.

The present invention also relates to a solid electrolyte comprising at least one Li—P—S—O product as defined above.

Preferably, the solid electrolyte according to the invention comprises a Li—P—S—O product of formula Li₇P₃S_{11-x/2}O_{x/2} as defined above, in particular having a crystal structure (with the space group P-1) and a volume V per formula unit (V/z) at room temperature comprised between 405 and 415 angstrom cube, as measured by X-Ray Diffraction.

The invention also concerns an electrochemical device comprising a solid electrolyte comprising at least a Li—P—S—O product of formula Li₇P₃S_{11-x/2}O_{x/2} as defined above, in particular having a crystal structure (with the space group P-1) and a volume V per formula unit (V/z) at room temperature comprised between 405 and 415 angstrom cube, as measured by X-Ray Diffraction.

Preferably in the electrochemical device, particularly a rechargeable electrochemical device, the solid electrolyte is a component of a solid structure for an electrochemical device selected from the group consisting of cathode, anode and separator.

Herein preferably the solid electrolyte is a component of a solid structure for an electrochemical device, wherein the solid structure is selected from the group consisting of cathode, anode and separator. Accordingly, the Li—P—S—O products according to the invention can be used alone or in combination with additional components for producing a solid structure for an electrochemical device, such as a cathode, an anode or a separator.

The electrode where during discharging a net negative charge occurs is called the anode and the electrode where during discharging a net positive charge occurs is called the cathode. The separator electronically separates a cathode and an anode from each other in an electrochemical device.

Suitable electrochemically active cathode materials and suitable electrochemically active anode materials are well known in the art. In an electrochemical device according to the invention, the anode preferably comprises graphitic carbon, metallic lithium, silicon compounds such as Si, SiOₓ, lithium titanates such as Li₄Ti₅O₁₂ or a metal alloy comprising lithium as the anode active material such as Sn.

In an electrochemical device according to the invention, the cathode preferably comprises a metal chalcogenide of formula LiMQ₂, wherein M is at least one metal selected from transition metals such as Co, Ni, Fe, Mn, Cr and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNixCo₁₋ₓO₂ (0<x<1), and spinel-structured LiMn₂O₄ and LiMn_{1.5}Ni_{0.5}O₄. Another preferred examples thereof may include lithium-nickel-manganese-cobalt-based metal oxide of formula LiNiₓMn_{y}Co_{z}O₂ (x+y+z=1, referred to as NMC), for instance LiNi_{1/3}Mn_{1/3}Co_{1/3}O₂, LiNi_{0.6}Mn_{0.2}Co_{0.2}O₂, and lithium-nickel-cobalt-aluminum-based metal oxide of formula LiNiₓCo_{y}Al_{z}O₂ (x+y+z=1, referred to as NCA), for instance LiNi_{0.8}Co_{0.15}Al_{0.05}O₂. Cathode may comprise a lithiated or partially lithiated transition metal oxyanion-based material such as LiFePO₄.

For example, the electrochemical device has a cylindrical-like or a prismatic shape. The electrochemical device can include a housing that can be from steel or aluminum or multilayered films polymer/metal foil.

A further aspect of the present invention refers to batteries, more preferably to an alkali metal battery, in particular to a lithium battery comprising at least one inventive electrochemical device, for example two or more. Electrochemical devices can be combined with one another in inventive alkali metal batteries, for example in series connection or in parallel connection.

The present invention also relates to a battery, preferably a lithium battery, comprising at least the Li—P—S—O product obtainable by the method of the invention or a product of formula Li₇P₃S_{11-x/2}O_{x/2} having a crystal structure (with the space group P-1) and a volume V per formula unit (V/z) at room temperature comprised between 405 and 415 angstrom cube, as measured by X-Ray Diffraction.

The battery where the Li—P—S—O product of the invention is used can be a lithium-ion or a lithium metal battery.

Typically, a lithium solid-state battery includes a positive electrode active material layer containing a positive electrode active material, a negative electrode active material layer containing a negative electrode active material, and a solid electrolyte layer formed between the positive electrode active material layer and the negative electrode active material layer. At least one of the positive electrode active material layer, the negative electrode active material layer, and the solid electrolyte layer includes a solid electrolyte as defined above.

The cathode of an all-solid-state electrochemical device usually comprises beside an active cathode material as a further component a solid electrolyte. Also the anode of an all-solid state electrochemical device usually comprises a solid electrolyte as a further component beside an active anode material.

The form of the solid structure for an electrochemical device, in particular for an all-solid-state lithium battery, depends in particular on the form of the produced electrochemical device itself. The present invention further provides a solid structure for an electrochemical device wherein the solid structure is selected from the group consisting of cathode, anode and separator, wherein the solid structure for an electrochemical device comprises a Li—P—S—O product according to the invention.

A plurality of electrochemical cells may be combined to an all solid-state battery, which has both solid electrodes and solid electrolytes.

The present invention also relates to an electrode comprising at least the Li—P—S—O product obtainable by the method of the invention.

The Li—P—S—O product disclosed above may be used in the preparation of an electrode. The electrode may be a positive electrode or a negative electrode.

The electrode typically comprises at least:
a metal substrate;
a layer of a composition (C) in contact with the metal substrate, said composition (C) comprising:
   (i) the Li—P—S—O product as disclosed above;
   (ii) at least one electroactive compound (EAC);
   (iii) optionally at least one material which conducts the Li ions other than the Li—P—S—O product of the invention;
   (iv) optionally at least one electrically-conductive material (ECM);
   (v) optionally a lithium salt (LIS);
   (vi) optionally at least one polymer binder material (P).

Preferably, the electrode according to the invention comprises a Li—P—S—O product of formula Li₇P₃S_{11-x/2}O_{x/2} as defined above, in particular having a crystal structure (with the space group P-1) and a volume V per formula unit (V/z) at room temperature comprised between 405 and 415 angstrom cube, as measured by X-Ray Diffraction.

The electro-active compound (EAC) denotes a compound which is able to incorporate or insert into its structure and to release lithium ions during the charging phase and the discharging phase of an electrochemical device. An EAC may be a compound which is able to intercale and deintercalate into its structure lithium ions. For a positive electrode, the EAC may be a composite metal chalcogenide of formula LiMeQ₂ wherein:
Me is at least one metal selected in the group consisting of Co, Ni, Fe, Mn, Cr, Al and V;
Q is a chalcogen such as 0 or S.

The EAC may more particularly be of formula LiMeO₂. Preferred examples of EAC include LiCoO₂, LiNiO₂, LiMnO₂, LiNiₓCo₁₋ₓO₂ (0<x<1), LiNiₓCo_{y}Mn_{z}O₂ (0<x, y, z<1 and x+y+z=1) for instance LiNi_{1/3}Mn_{1/3}Co_{1/3}O₂, LiNi_{0.6}Mn_{0.2}Co_{0.2}O₂, LiNi_{0.8}Mn_{0.1}Co_{0.1}O₂, Li(NiₓCo_{y}Al_{z})O₂ (x+y+z=1) and spinel-structured LiMn₂O₄ and Li(Ni_{0.5}Mn_{1.5})O₄.

The EAC may also be a lithiated or partially lithiated transition metal oxyanion-based electro-active material of formula M₁M₂(JO4)_{f}E_{1-f}, wherein:
M₁ is lithium, which may be partially substituted by another alkali metal representing less that 20% of M1;
M₂ is a transition metal at the oxidation level of +2 selected from Fe, Co, Mn, Ni or mixtures thereof, which may be partially substituted by one or more additional metals at oxidation levels between +1 and +5 and representing less than 35% of the M₂ metals, including 0;
JO₄ is any oxyanion wherein J is either P, S, V, Si, Nb, Mo or a combination thereof;
E is a fluoride, hydroxide or chloride anion;
f is the molar fraction of the JO₄ oxyanion, generally comprised between 0.75 and 1.

The M₁M₂(JO₄)_{f}E_{1-f} electro-active material as defined above is preferably phosphate-based. It may exhibit an ordered or modified olivine structure.

For a positive electrode, the EAC may also be sulfur or Li₂S.

For a positive electrode, the EAC may also be a conversion-type materials such as FeS₂ or FeF₂ or FeF₃.

For a negative electrode, the EAC may be selected in the group consisting of graphitic carbons able to intercalate lithium. More details about this type of EAC may be found in Carbon 2000, 38, 1031-1041. This type of EAC typically exist in the form of powders, flakes, fibers or spheres (e.g. mesocarbon microbeads).

The EAC may also be: lithium metal; lithium alloy compositions (e.g. those described in U.S. Pat. No. 6,203,944 and in WO 00/03444); lithium titanates, generally represented by formula Li₄Ti₅O₁₂; these compounds are generally considered as “zero-strain” insertion materials, having low level of physical expansion upon taking up the mobile ions, i.e. Li+; lithium-silicon alloys, generally known as lithium silicides with high Li/Si ratios, in particular lithium silicides of formula Li_{4.4}Si and lithium-germanium alloys, including crystalline phases of formula Li_{4.4}Ge. EAC may also be composite materials based on carbonaceous material with silicon and/or silicon oxide, notably graphite carbon/silicon and graphite/silicon oxide, wherein the graphite carbon is composed of one or several carbons able to intercalate lithium.

The ECM is typically selected in the group consisting of electro-conductive carbonaceous materials and metal powders or fibers. The electron-conductive carbonaceous materials may for instance be selected in the group consisting of carbon blacks, carbon nanotubes, graphite, graphene and graphite fibers and combinations thereof. Examples of carbon blacks include ketjen black and acetylene black. The metal powders or fibers include nickel and aluminum powders or fibers.

The lithium salt (LIS) may be selected in the group consisting of LiPF₆, lithium bis(trifluoromethanesulfonyl)imide, lithium bis(fluorosulfonyl)imide, LiB(C₂O₄)₂, LiAsF₆, LiCIO₄, LiBF₄, LiAlO₄, LiNO₃, LiCF₃SO₃, LiN(SO₂CF₃)₂, LiN(SO₂C₂F₅)₂, LiC(SO₂CF₃)₃, LiN(SO₃CF₃)₂, LiC₄FSO₃, LiCF₃SO₃, LiAlCl₄, LiSbF₆, LiF, LiBr, LiCl, LiOH and lithium 2-trifluoromethyl-4,5-dicyanoimidazole.

The function of the polymeric binding material (P) is to hold together the components of the composition. The polymeric binding material is usually inert. It preferably should be also chemically stable and facilitate the electronic and ionic transport. The polymeric binding material is well known in the art. Non-limitative examples of polymeric binder materials include notably, vinylidenefluoride (VDF)-based (co)polymers, styrene-butadiene rubber (SBR), styrene-ethylene-butylene-styrene (SEBS), carboxymethylcellulose (CMC), polyamideimide (PAI), poly(tetrafluoroethylene) (PTFE) and poly(acrylonitrile) (PAN) (co)polymers.

The proportion of the Li—P—S—O product of the invention in the composition may be between 0.1 wt % to 80 wt %, based on the total weight of the composition. In particular, this proportion may be between 1.0 wt % to 60 wt %, more particularly between 5 wt % to 30 wt %. The thickness of the electrode is not particularly limited and should be adapted with respect to the energy and power required in the application. For example, the thickness of the electrode may be between 0.01 mm to 1,000 mm.

The present invention also relates to a separator comprising at least the Li—P—S—O product obtainable by the method of the invention.

The Li—P—S—O product according to the invention may also be used in the preparation of a separator. A separator is an ionically permeable membrane placed between the anode and the cathode of a battery. Its function is to be permeable to the lithium ions while blocking electrons and assuring the physical separation between the electrodes.

The separator of the invention typically comprises at least:
the Li—P—S—O product as disclosed above;
optionally at least one polymeric binding material (P);
optionally at least one metal salt, notably a lithium salt;
optionally at least one plasticizer.

Preferably, the separator according to the invention comprises a Li—P—S—O product of formula Li₇P₃S_{11-x/2}O_{x/2} as defined above, in particular having a crystal structure (with the space group P-1) and a volume V per formula unit (V/z) at room temperature comprised between 405 and 415 angstrom cube, as measured by X-Ray Diffraction.

The electrode and the separator may be prepared using methods well-known to the skilled person. This usually mixing the components in an appropriate solvent and removing the solvent. For instance, the electrode may be prepared by the process which comprises the following steps:
a slurry comprising the components of composition and at least one solvent is applied onto the metal substrate;
the solvent is removed.

Usual techniques known to the skilled person are the following ones: coating and calendaring, dry and wet extrusion, 3D printing, sintering of porous foam followed by impregnation. Usual techniques of preparation of the electrode and of the separator are provided in Journal of Power Sources, 2018 382, 160-175.

The electrochemical devices, notably batteries such as solid state batteries described herein, can be used for making or operating cars, computers, personal digital assistants, mobile telephones, watches, camcorders, digital cameras, thermometers, calculators, laptop BIOS, communication equipment or remote car locks, and stationary applications such as energy storage devices for power plants.

The electrochemical devices, notably batteries such as solid state batteries described herein, can notably be used in motor vehicles, bicycles operated by electric motor, robots, aircraft (for example unmanned aerial vehicles including drones), ships or stationary energy storages. Preferred are mobile devices such as are vehicles, for example automobiles, bicycles, aircraft, or water vehicles such as boats or ships.

Other examples of mobile devices are those which are portable, for example computers, especially laptops, telephones or electrical power tools, for example from the construction sector, especially drills, battery-driven screwdrivers or battery-driven tackers.

Should the disclosure of any patents, patent applications, and publications which are incorporated herein by reference conflict with the description of the present application to the extent that it may render a term unclear, the present description shall take precedence.

### FIGURES

FIG. 1: Comparison of the XRD patterns of the simulated pattern of Li₄P₂S₆ [1] and the synthesized Li₄P₂S₆ (Example 1).

FIG. 2: Comparison of the Raman spectra of the synthesized Li₄P₂S₆ (Example 1), the ball-milled product that was synthesized using Li₂CO₃ as one of the precursors (Example 2), the crystalline Li₇P₃S_{11-x/2}O_{x/2} that was formed by annealing Example 2 (Example 3), and the crystalline Li₇P₃S₁₁ that was synthesized from the conventional reagents Li₂S and P₂S₅ (Example 4).

FIG. 3: ³¹P Nuclear-Magnetic-Resonance (NMR) Magic-Angle-Spinning (MAS) spectra of the synthesized Li₄P₂S₆ (Example 1), the ball-milled product that is synthesized using Li₂CO₃ as one of the precursors (Example 2), the crystalline Li₇P₃S_{11-x/2}O_{x/2} that was formed by annealing the Example 2 (Example 3), and the crystalline Li₇P₃S₁₁ that was synthesized from the conventional reagents Li₂S and P₂S₅ (Example 4). Characteristic chemical shift intervals of different structural moieties (P₂O₇⁴⁻, PO₃S₃³⁻, PS₄³⁻, P₂S₇⁴⁻ and P₂S₆⁴⁻) are marked in different tones of grey and are labelled.

FIG. 4: Comparison of the XRD patterns of the crystalline Li₇P₃S_{11-x/2}O_{x/2} that was synthesized using Li₂CO₃ as one of the precursors (Example 3), the crystalline Li₇P₃S₁₁ that was synthesized from the conventional reagents Li₂S and P₂S₅ (Example 4), and the simulated pattern of Li₇P₃S₁₁ [2].

FIG. 5: Results of the Le Bail refinements of the Examples 3 and 4. The Bragg reflections are indicated with black vertical lines and the corresponding phases are noted on their right, the fits are plotted with a solid black line, and the collected data are shown in black hollow spheres.

FIG. 6: Deconvolution of the signals coming from the structural moieties PS₄³⁻, P₂S₇⁴⁻ and P₂S₆⁴⁻ in the Raman spectrum of Example 3. The relative ratios of the peak areas are also noted on the top left of the figure.

FIG. 7: Deconvolution of the signals coming from the structural moieties PS₄³⁻, P₂S₇⁴⁻ and P₂S₆⁴⁻ in the Raman spectrum of Example 4. The relative ratios of the peak areas are also noted on the top left of the figure.

FIG. 8: Comparison of the ionic conductivity values versus inverse temperature (1/T with T in ° K) of the crystalline Li₇P₃S_{11-x/2}O_{x/2} that was synthesized using Li₂CO₃ as one of the precursors (Example 3) and of the crystalline Li₇P₃S₁₁ that was synthesized from the conventional reagents Li₂S and P₂S₅ (Example 4).

### EXAMPLES

The disclosure will now be illustrated with working examples, which is intended to illustrate the working of disclosure and not intended to take restrictively to imply any limitations on the scope of the present disclosure. Other examples are also possible which are within the scope of the present disclosure.

### Example 1

Li₂S and P₂S₅ (both produced by Sigma Aldrich) were used as starting materials. 5 g of total powder at a molar ratio of 2:1 were put in a 45 mL ZrO₂ jar with 15 ZrO₂ balls (3 g/ball, 10 mm diameter) in an Ar filled glovebox. The jar was sealed with scotch and parafilm to prevent air exposure, then was taken out of the glovebox and was placed in Fritzch Planetary Micro Mill Pulverisette 7. It was ball-milled with 510 RPM rotating speed for 64 hours while employing 15 minute breaks in every 15 minutes of milling, in order to prevent excessive heating of the jar. The jar was then moved to an Ar filled glovebox to recover the powder. Then, the resulting white powder was pelletized at 530 MPa with a 10 mm diameter die. The pellet was vacuum sealed in a carbon coated quartz tube and the tube was heated to 350° C. with 5° C./min heating rate, and was kept at the same temperature for 36 hours. After the annealing step, the tube was slowly cooled down to RT, and it was opened in an Ar filled glovebox.

The overall reaction is then:

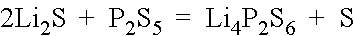

### Example 2

500 mg of the Example 1, 76 mg of Se (produced by Alfa Aesar), and 44 mg of Li₂CO₃ (produced by Sigma Aldrich) were mixed in a dry room and put in a 45 mL ZrO₂ jar with 8 ZrO₂ balls (3 g/ball, 10 mm diameter). The jar was sealed with scotch and parafilm to prevent air exposure, then was taken out of the dry room and was placed in Fritzch Planetary Micro Mill Pulverisette 7. It was ball-milled with 510 RPM rotating speed for 76 hours while employing 15 minute breaks in every 15 minutes of milling, in order to prevent excessive heating of the jar. The jar was then moved to an Ar filled glovebox to recover the powder.

The overall reaction is then:

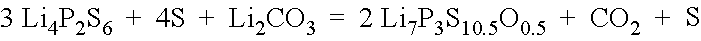

(extra sulfur was added to compensate for the possible evaporation of sulfur during the reaction on the left hand side).

### Example 3

The Example 2 was pelletized at 530 MPa with a 6 mm diameter die. The pellet was vacuum sealed in a carbon coated quartz tube and the tube was annealed at 260° C. for 1 hour. After the annealing step, the tube was slowly cooled down to RT, and it was opened in an Ar filled glovebox to recover the sample.

### Example 4 (Comparative)

Li₂S and P₂S₅ (both produced by Sigma Aldrich) were used as starting materials. 1.5 g of total powder at a molar ratio of 7:3 were put in a 45 mL ZrO₂ jar with 12 ZrO₂ balls (3 g/ball, 10 mm diameter) in an Ar filled glovebox. The jar was sealed with scotch and parafilm to prevent air exposure, then was taken out of the glovebox and was placed in Fritzch Planetary Micro Mill Pulverisette 7. It was ball-milled with 510 RPM rotating speed for 76 hours while employing 15 minute breaks in every 5 minutes of milling, in order to prevent excessive heating of the jar. The jar was then moved in an Ar filled glovebox to collect the powder. The resulting white powder was pelletized at 530 MPa with a 10 mm diameter die. The pellet vacuum was sealed in a carbon coated quartz tube and the tube was annealed at 200° C. for 168 hours. After the annealing step, the tube was slowly cooled down to RT, and it was opened in an Ar filled glovebox.

The overall reaction is then:

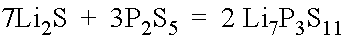

### Characterization Tools:

X-ray diffraction of the samples were collected using a Bruker D8 diffractometer with Cu Kα radiation at RT. The samples were sealed in a Be-equipped sample holder in an Ar filled glovebox prior to the experiment. The diffractions were collected in 2θ range of 10° to 100° in 13 hours. The lattice parameters were determined by Le Bail method used on the diffraction profiles using Full-Prof Suite. The Le Bail refinements of the XRD patterns of the Examples 3 and 4 were limited in a shorter 2θ range (10° to 40°) to increase the accuracy of the lattice parameters.

The Raman spectra were collected using a Raman DXR Microscope (Thermo Fischer Scientific) with excitation laser beam wavelength of 532 nm and a low laser power of 0.1 mW to prevent excessive heating of the sample. The fitting processes were performed using Omnic Software of Thermo Fischer Scientific.

Before the impedance spectroscopy measurements, powder samples were cold-pressed in an Ar filled glovebox. The powders of Examples 2 and 3 were pressed with a 6 mm diameter die with 530 MPa pressure, while the Example 4 powder was pressed with a 10 mm diameter die with 530 MPa pressure. The pellets were then sandwiched between pre-dried carbon paper electrodes, and then loaded into air-tight sample holders. The AC impedance spectra were collected by using Biologic MTZ-35 frequency response analyser. During the measurements, the AC potential for excitation was set at 50 mV for all the samples. The frequency range of the measurement of the Example pellet 2 was 0.05 Hz to 30 MHz, whereas a range of 1 Hz to 30 MHz was applied in the measurements of the Examples 3 and 4 pellets. The spectrum of each sample was recorded at stabilized temperature values varying between −30° C. and 50° C. in steps of 10° C. The ionic conductivity values were obtained by fitting the data into equivalent circuit models using ZView software. The slopes of the σT versus 1/T plots were calculated to determine activation energy values.

### EXPERIMENTAL RESULTS

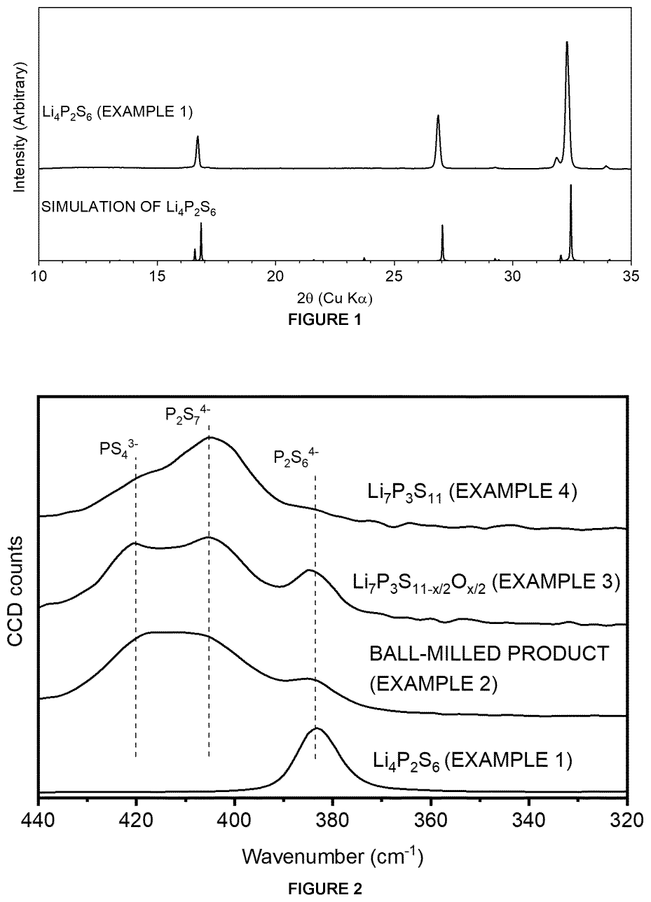

The Bragg diffractions observed in the XRD pattern of the Example 1 show correlation to the simulated peak positions of crystalline Li₄P₂S₆ [1], as shown in FIG. 1. In the Raman spectrum of the Example 1 in FIG. 2, the only peak centered at 383 cm⁻¹ is due to the vibration of P—S bond in P₂S₆⁴⁻ anion [3,4]. Hence, the sample was considered phase pure and was used as a precursor for the syntheses of the Examples 2 and 3. Without being bonded to any theory, the overall reaction observed in the Example 1 can be schematized as follows:

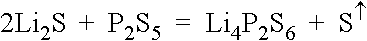

The Example 2 was synthesized through mechanochemical synthesis route.

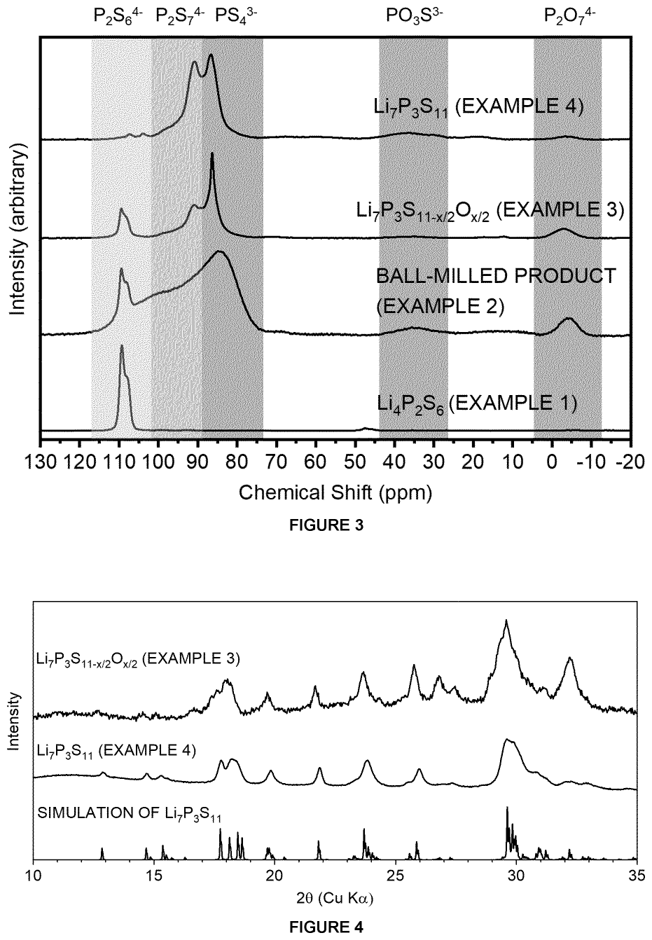

After the mechanochemical reaction, the vibrations of P—S bonds in P₂S₇⁴⁻ and PS₄³⁻ moieties appear in the Raman spectrum of the Example 2, see FIG. 2. The intensity of P₂S₆⁴⁻ signal in the Example 2 decreased drastically and the structural units PS₄³⁻(observed at 420 cm⁻¹ [5]) and P₂S₇⁴⁻ (observed at 405 cm⁻¹ [5]) appeared, which indicates that S and Li₂CO₃ reacted with the P₂S₆⁴⁻ moieties in Li₄P₂S₆ (Example 1) whereby some of the phosphorus ions were oxidized from +4 to +5 formal charge. Comparison of the ³¹P Nuclear-Magnetic-Resonance (NMR) Magic-Angle-Spinning (MAS) spectra of the Examples 3 and 4 confirms these conclusions, see FIG. 3. The relative intensities of P₂S₆⁴⁻ signals at 108 and 109.4 ppm [6] decrease and the formations of new structural units are evidenced by the signals at 84-86 ppm for PS₄³⁻ and 90-100 ppm for P₂S₇⁴⁻ [5,6]. In addition, some PO₃S³⁻ (35 ppm [6]) and P₂O (−4 ppm [6]) species are also present in the Examples 2, 3 and 4. The relatively small quantities of oxysulfide and oxide species in the Example 4 arose from limited exposure to humid air during sample preparation, whereas relatively higher quantities of oxysulfide and oxide species in the Examples 2 and 3 originate from the contribution of O²⁻ ions in Li₂CO₃ to the overall reaction.

The XRD patterns of the Examples 3 and 4 showed correlation to the simulated pattern of crystalline Li₇P₃S₁₁ [2], as shown in FIG. 4. Sharper diffraction peaks of the Example 4 indicates a better overall crystallinity compared to the Example 3. Extra diffraction peaks such as the ones at 2θ=16.6°, 17.4°, 24.3°, 26.8°, 27.4°, 28.9°, 32.2° indicates that there is/are extra crystalline phase(s) in addition to an Li₇P₃S₁₁-type phase in the Example 3.

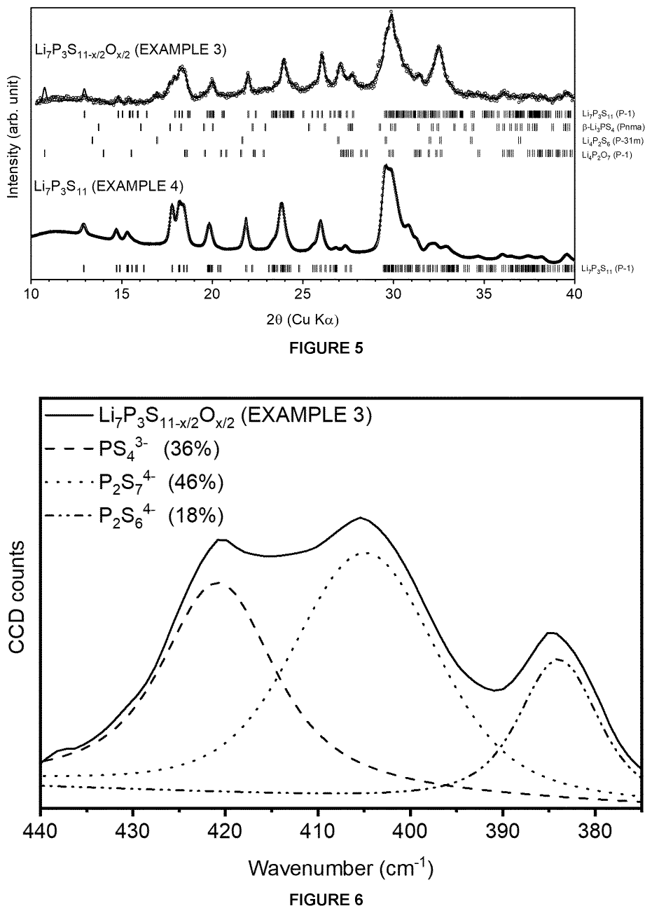

FIG. 5 shows the Le Bail method results of the diffraction patterns of the Examples 3 and 4. The Example 4 consists of only an Li₇P₃S₁₁-type crystalline phase with the P-1 space group, whereas the Example 3 consists of 4 crystalline phases as the following: Li₇P₃S₁₁-type (P-1 [2]), β-Li₃PS₄ (Pnma [13]), Li₄P₂S₆ (P-31m [3]) and arguably Li₄P₂O₇ (P-1 [14]). The ³¹P NMR spectra of the Example 3 indicates the presence of P₂O₇⁴⁻ units but the diffraction peaks of a Li₄P₂O₇-type phase were not clearly observed.

The Le Bail method results show (Table 1) that the Li₇P₃S₁₁-type phase in the Example 3 has significantly lower a, b and c lattice parameters compared to the ones of Li₇P₃S₁₁ from the Example 4 or from literature [2], indicating that the unit cell of the Li₇P₃S₁₁-type phase tends to be contracted, which signals the presence of oxide species in the structure because the shorter bond length between P—O compared to P—S leads to a decrease in the lattice parameters [15]. In other terms, this result confirms that oxygen atoms are introduced into the crystal structure of Li₇P₃S₁₁. Taking into account the results of ³¹P Nuclear-Magnetic-Resonance (NMR) Magic-Angle-Spinning (MAS) spectroscopy, it is concluded that PO₃S³⁻ and possibly P₂O₇⁴⁻ units are present in the Li₇P₃S₁₁-type phase of the Example 3.

TABLE 1
Lattice parameters of the Examples 3 and 4 obtained by Le Bail
method and lattice parameters reported in the literature [2]

| | a | b | c | alpha | beta | gamma | V |
|---|---|---|---|---|---|---|---|
| | (Å) | (Å) | (Å) | (°) | (°) | (°) | (Å³) |
| Example 3 | 12.35 | 6.01 | 12.43 | 102.44 | 112.88 | 74.71 | 813 |
| Example 4 | 12.46 | 6.05 | 12.53 | 103.14 | 113.33 | 74.70 | 828 |
| Reference [2] | 12.50 | 6.03 | 12.53 | 102.85 | 113.20 | 74.47 | 829 |

The Raman spectra of the Examples 3 and 4 show the presence of bond vibrations of PS₄³⁻, P₂S₇⁴⁻ and P₂S₆⁴⁻ moieties at 421 cm⁻¹, 404 cm⁻¹ and 383 cm⁻¹, respectively, see FIG. 2.

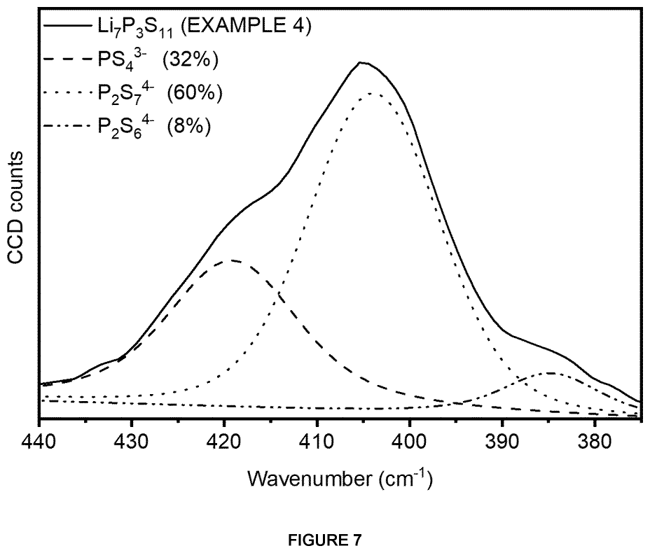

Relative signal ratios between PS₄³⁻, P₂S₇⁴⁻ and P₂S₆⁴⁻ species were calculated by deconvoluting the Raman spectra of the Examples 3 and 4 as shown in FIGS. 6 and 7. Relative signal ratio between PS₄³⁻ and P₂S₇⁴⁻ species in the Example 4 was calculated to be 1:1.89 which is the expected ratio for crystalline Li₇P₃S₁₁ [5,8]. A small quantity of P₂S₆⁴⁻ units was present in an amorphous phase since only one crystalline phase (Li₇P₃S₁₁-type, not consisting of P₂S₆⁴⁻) is present according to XRD (see FIGS. 4 and 5). The relative signal ratio between PS₄³⁻ and P₂S₇⁴⁻ species in the Example 3 was calculated to be 1:1.28, which indicates that the material was richer in PS₄³⁻ due to the presence of β-Li₃PS₄ [13]. The relative intensity of the peak of P₂S₆⁴⁻ units was higher in the case of the Example 3, which is consistent with the use of Li₄P₂S₆ synthesized in the Example 1 as precursor, a part of which may have remained unreacted. These results clearly indicates that the materials which were synthesized from the reagents Li₂S and P₂S₅ as in the Example 4 and from Li₄P₂S₆ and Li₂CO₃ as in the Example 3 possess some similarities in terms of structural properties.

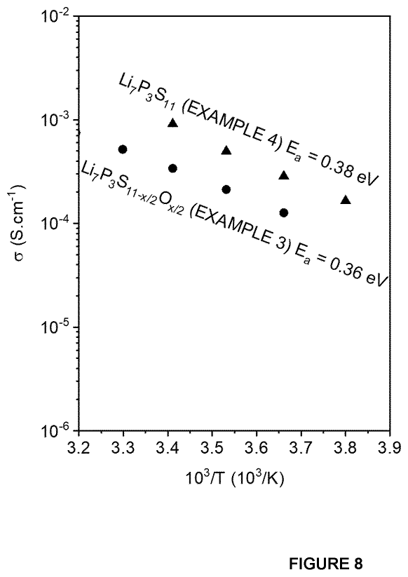

The ionic conductivities of the Examples 3 and 4 are shown as a function of temperature (−30° C. to 20° C.) in FIG. 8. The activation energies were calculated from the σT vs 1/T plots using Equation 1:

$$σ * T = {σ}_{0} * {e}^{- \frac{Ea}{kT}} \qquad Equation 1$$

The Example 4 demonstrated 9×10⁻⁴ S·cm⁻¹ conductivity at 20° C. with an activation energy of 0.38 eV in accordance with the literature values [8]. The Example 3 demonstrated a 3×10⁻⁴ S·cm⁻¹ conductivity at 20° C. and a more advantageous activation energy of 0.36 eV. The lower conductivity of the Example 3 probably originates from the crystalline impurities present in the material.

The results obtained from different characterization tools indicate that crystalline oxysulfide Li₇P₃S_{11-x/2}O_{x/2} can be synthesized by using Li₂CO₃, Li₄P₂S₆ and S. This work shows that an Li—P—S compound and Li₂CO₃ can be used as precursors for the syntheses Li—P—S—O oxysulfides.

The Li₇P₃S₁₁-type phase in Li₇P₃S_{11-x/2}O_{x/2} (Example 3) has significantly smaller a, b and c lattice parameters compared to the values reported in the literature, and to the ones of the crystalline Li₇P₃S₁₁ that was synthesized by using Li₂S and P₂S₅ as reagents (Example 4). This is an evidence of substitution of sulfur atom by oxygen atom in the lattice of Li₇P₃S₁₁-type phase in Li₇P₃S_{11-x/2}O_{x/2} (Example 3).

Crystalline β-Li₃PS₄, Li₄P₂S₆ and possibly Li₄P₂O₇ form as by-products. These impurities might be avoided by changing ball-milling (speed, time, cooling breaks, ball-milling jar nature and volume, ball milling ball size, nature and quantity etc.) and annealing time and temperature of the Example 3. The transport properties of pure Li₇P₃S₁₁ (Example 4) and Li₇P₃S_{11-x/2}O_{x/2} (Example 3) are of the same order of magnitude. Ionic conductivity of the Example 3 might have a dependence on the quantities of the afore-mentioned impurities.

### REFERENCES

[1] S. Neuberger, S. P. Culver, H. Eckert, W. G. Zeier, J. Schmedt auf der Günne, Refinement of the crystal structure of Li4P₂S₆ using NMR crystallography, Dalt. Trans. (2018). doi:10.1039/C8DT02619J.
[2] H. Yamane, M. Shibata, Y. Shimane, T. Junke, Y. Seino, S. Adams, K. Minami, A. Hayashi, M. Tatsumisago, Crystal structure of a superionic conductor, Li7P₃S₁₁, Solid State Ionics. 178 (2007) 1163-1167. doi:10.1016/j.ssi.2007.05.020.
[3] C. Dietrich, M. Sadowski, S. Sicolo, D. A. Weber, S. J. Sedlmaier, K. S. Weldert, S. Indris, K. Albe, J. Janek, W. G. Zeier, Local Structural Investigations, Defect Formation, and Ionic Conductivity of the Lithium Ionic Conductor Li4P2S6, Chem. Mater. 28 (2016) 8764-8773. doi:10.1021/acs.chemmater.6b04175.
[4] M. Tachez, J. Malugani, R. Mercier, R. Guy, Ionic conductivity of and phase transition in Li thiophosphate Li3PS4, Solid State Ionics. 14 (1984) 181-185. doi:http://dx.doi.org/10.1016/0167-2738(84)90097-3.
[5] C. Dietrich, D. A. Weber, S. J. Sedlmaier, S. Indris, S. P. Culver, D. Walter, J. Janek, W. G. Zeier, Lithium ion conductivity in Li2S—P2S5 glasses—building units and local structure evolution during the crystallization of superionic conductors Li3PS4, Li7P3S11 and Li4P2S7, J. Mater. Chem. A. 5 (2017) 18111-18119. doi:10.1039/C7TA06067J.
Inorg. Chem. 56 (2017) 6681-6687. doi:10.1021/acs.inorgchem.7b00751.
[6] S. Kmiec, A. Joyce, S. W. Martin, Glass formation and structural analysis of Na 4 P 2 S 7-x O x, 0≤x≤7 sodium oxy-thiophosphate glasses, J. Non. Cryst. Solids. 498 (2018) 177-189. doi:10.1016/j.jnoncrysol.2018.06.007.
[7] Ö. U. Kudu, T. Famprikis, B. Fleutot, M.-D. Braida, T. Le Mercier, M. S. Islam, C. Masquelier, A review of structural properties and synthesis methods of solid electrolyte materials in the Li2S—P₂S₅ binary system, J. Power Sources. 407 (2018) 31-43. doi:10.1016/j.jpowsour.2018.10.037.
[8] Y. Wang, D. Lu, M. Bowden, P. Z. El Khoury, K. S. Han, Z. D. Deng, J. Xiao, J.-G. Zhang, J. Liu, Formation mechanism of Li7P3S11 solid electrolytes through liquid phase synthesis, Chem. Mater. 30 (2018) 990-997. doi:10.1021/acs.chemmater.7b04842.
[9] T. Ohtomo, A. Hayashi, M. Tatsumisago, K. Kawamoto, Characteristics of the Li2O—Li2S—P2S 5 glasses synthesized by the two-step mechanical milling, J. Non. Cryst. Solids. 364 (2013) 57-61. doi:10.1016/j.jnoncrysol.2012.12.044.
[10] B. Huang, X. Yao, Z. Huang, Y. Guan, Y. Jin, X. Xu, Li3PO4—doped Li7P3S11 glass-ceramic electrolytes with enhanced lithium ion conductivities and application in all-solid-state batteries, J. Power Sources. 284 (2015) 206-211. doi:10.1016/j.jpowsour.2015.02.160.
[11] K. Minami, A. Hayashi, M. Tatsumisago, Electrical and electrochemical properties of Li2S-P2S5-P2O5 glass-ceramic electrolytes, Solid State Ionics. 179 (2008) 1282-1285. doi:j.ssi.2008.02.014.
[12] K. Minami, A. Hayashi, S. Ujiie, M. Tatsumisago, Electrical and electrochemical properties of glass-ceramic electrolytes in the systems Li2S—P₂S₅—P2S3 and Li2S-P2S5-P2O5, Solid State Ionics. 192 (2011) 122-125. doi:10.1016/j.ssi.2010.06.018.
[13] H. Stöffer, T. Zinkevich, M. Yavuz, A. Senyshyn, J. Kulisch, P. Hartmann, T. Adermann, S. Randau, F. H. Richter, J. Janek, S. Indris, H. Ehrenberg, Li+ Ion Dynamics in β-Li3PS4 Observed by NMR: Local Hopping and Long-Range Transport, J. Phys. Chem. C. 122 (2018) 15954-15965. doi:10.1021/acs.jpcc.8b05431.
[14] B. Raguž, K. Wittich, R. Glaum, Two New, Metastable Polymorphs of Lithium Pyrophosphate Li4P2O7, Eur. J. Inorg. Chem. 2019 (2019) 1688-1696. doi:10.1002/ejic.201801100.
[15] H. Liu, Z. Yang, Q. Wang, X. Wang, X. Shi, Atomistic insights into the screening and role of oxygen in enhancing the Li+ conductivity of Li7P3S11-x/2Ox/2 solid-state electrolytes, Phys. Chem. Chem. Phys. 21 (2019) 26358-26367. doi:10.1039/c9cp05329h.
[16] Y. Seino, T. Ota, K. Takada, A. Hayashi, M. Tatsumisago, A sulphide lithium super ion conductor is superior to liquid ion conductors for use in rechargeable batteries, Energy Environ. Sci. 7 (2014) 627-631. doi:10.1039/C3EE41655K.
[17] Y. Guo, H. Guan, W. Peng, X. Li, Y. Ma, D. Song, H. Zhang, C. Li and L. Zhang, Enhancing the electrochemical performances of Li₇P₃S₁₁ electrolyte through P₂O₅ substitution for all-solid-state lithium battery, Solid States Ionics. 358 (2020) 115506. doi:10.1016/j.ssi.2020.115506.

1. A method of preparing a Li—P—S—O product, the method comprising the following steps:
(a) mixing at least Li₄P₂S₆, sulfur, an oxygen containing reagent selected from Li₂CO₃, Li₂O or mixture thereof and optionally Li₂S to obtain a first mixture;
(b) heating the first mixture in an inert atmosphere, under vacuum or under H₂S flow, for a period of time comprised from 0.1 hour to 200 hours and at a temperature comprised from 150° C. to 600° C. to produce the Li—P—S—O product; and
(c) cooling and optionally powdering the Li—P—S—O product.

2. The method according to claim 1, wherein the Li—P—S—O product is chosen from the group consisting of Li₇P₃S_{11-x/2}O_{x/2}, Li₃PS_{4-x/2}O_{x/2} and Li₇PS_{6-5x/2} O_{5x/2}, wherein 0<x≤1.

3. The method according to claim 1, wherein the oxygen containing reagent comprises Li₂CO₃.

4. The method according to claim 1, wherein the temperature in step (b) is comprised from 180° C. to 300° C.

5. The method according to claim 1, wherein the heating in step (b) is made over a period of time comprised from 0.5 hours to 100 hours.

6. The method according to claim 1, wherein Li₄P₂S₆ is obtained from the reaction between Li₂S and P₂S₅.

7. A Li—P—S—O product obtained by the method of claim 1.

8. A Li—P—S—O product of formula Li₇P₃S_{11-x/2}O_{x/2} where 0<x≥1 having a crystal structure with the space group P-1 and a volume V per formula unit at room temperature comprised between 405 and 415 angstrom cube, as measured by X-Ray Diffraction.

9. The Li—P—S—O product of claim 8 wherein x=1.

10. A method comprising producing a solid electrolyte with the Li—P—S—O product of claim 7, alone or in combination with any crystalline or amorphous Li-material.

11. A solid electrolyte comprising at least one Li—P—S—O product of claim 7.

12. An electrode comprising:
a metal support;
a layer of a composition (C) in contact with the metal substrate, said composition (C) comprising:
(i) the Li—P—S—O product as claimed in claim 7;
(ii) at least one electroactive compound (EAC);
(iii) optionally at least one material which conducts the Li ions other than the Li—P—S—O product of the invention;
(iv) optionally at least one electrically-conductive material (ECM);
(v) optionally a lithium salt (LIS);
(vi) optionally at least one polymer binder material (P).

13. A separator comprising:
the Li—P—S—O product as claimed in claim 7;
optionally at least one polymeric binding material (P);
optionally at least one metal salt, notably a lithium salt;
optionally at least one plasticizer.

14. A battery comprising at least one Li—P—S—O product according to claim 7.
